(19) United States
(12) Patent Application Publication
(10) Pub. No.: US 2012/0060384 A1
(43) Pub. Date: Mar. 15, 2012

(54) MACHINE TOOL AND METHOD FOR DETERMINING THE POSITION OF A WORKPIECE IN A MACHINE TOOL

(75) Inventors: Andreas Grözinger, Renningen (DE); Marc Konrad, Herzogenaurach (DE)

(73) Assignee: Siemens Aktiengesellschaft, Munchen (DE)

(21) Appl. No.: 13/046,233

(22) Filed: Mar. 11, 2011

Related U.S. Application Data
(60) Provisional application No. 61/339,961, filed on Mar. 12, 2010.

(30) Foreign Application Priority Data
Mar. 12, 2010 (DE) 10 2010 002 816.9

(51) Int. Cl. G01B 5/008

(52) U.S. Cl. 33/503

(57) ABSTRACT

A method for determining a position of a workpiece clamped in a workpiece clamping device in a machine tool includes the steps of successively positioning a position measuring head of a position measuring device held in the hand of an operator at different positions on a surface of the workpiece, determining, after each positioning of the position measuring head, a position of the position measuring head in relation to a machine coordinate system of the machine tool, and determining from the determined positions in the machine coordinate system the position of the workpiece in relation to the machine coordinate system. A machine tool configured to a carry out the method is also disclosed. The position of a workpiece clamped in a workpiece clamping device in a machine tool can thus be determined in a simple manner.

### CROSS-REFERENCES TO RELATED APPLICATIONS

This application claims the priority of German Patent Application, Serial No. 10 2010 002 816.9 filed Mar. 12, 2010, pursuant to 35 U.S.C. 119(a)-(d), the content of which is incorporated herein by reference in its entirety as if fully set forth herein.

### BACKGROUND OF THE INVENTION

The present invention relates to a method for determining the position of a workpiece clamped in a workpiece clamping device in a machine tool. The present invention also relates a machine tool employing this method.

The following discussion of related art is provided to assist the reader in understanding the advantages of the invention, and is not to be construed as an admission that this related art is prior art to this invention.

Before a workpiece can be machined with a machine tool, the position and, if appropriate, the alignment of the workpiece in relation to the machine coordinate system of the machine tool must be determined. A measuring probe is generally used for this purpose, wherein in commercially available machine tools, the measuring operation is typically performed in two measuring steps. After the operator has clamped the measuring probe in the tool holding device of the machine tool, he moves the measuring probe in a tapping mode or a hand wheel mode close to the predetermined measurement locations. At each measuring point, the machine tool carries out an automatic measuring movement of the measuring probe and determines in this way the position of the workpiece and, if desired, orientation of the workpiece. As already mentioned, with commercially available machine tools the operator moves the measuring probe via the control of the machine tool with a hand wheel or by momentarily tapping a directional key which each time the key is tapped causes the measuring probe to move into a specific direction. This manually controlled movement of the measuring probe is quite complicated, and the operator spends a relatively long time to move the measuring probe by hand into the vicinity of the location to be measured, which serves as a starting point for the subsequent automated measuring operation. The measuring probe in commercially available machine tools is therefore pre-positioned manually (hand wheel mode or tapping mode).

It would therefore be desirable and advantageous to address this problem and to obviate other prior art shortcomings by providing a less complex method for determining of a position of a workpiece clamped in a workpiece clamping device of a machine tool.

### SUMMARY OF THE INVENTION

According to one aspect of the present invention, a method for determining a position of a workpiece clamped in a workpiece clamping device in a machine tool includes the steps of successively positioning a position measuring head of a position measuring device held in the hand of an operator at different positions on a surface of the workpiece, determining, after each positioning of the position measuring head, a position of the position measuring head in relation to a machine coordinate system of the machine tool, and determining from the determined positions in the machine coordinate system the position of the workpiece in relation to the machine coordinate system.

According to yet another aspect of the invention, a machine tool includes a plurality of transmitters arranged on the machine tool, a workpiece clamping device for clamping a workpiece, a position measuring device having a position measuring head with a receiver, wherein the position measuring device is constructed to be held in the hand of an operator. The machine tool further includes an evaluation device determining from signals transmitted by the transmitters arranged on the machine tool a position of the position measuring head in three-dimensional space, a control device operatively connected to the position measuring device, wherein the control device converts instructions of a parts program to coordinates in a machine coordinate system. The machine tool also includes a drive device which moves a tool based on the converted instructions in the machine coordinate system. The machine tool is operated by having the operator successively position the position measuring head at different positions on the surface of the workpiece. The evaluation device then determines, after each positioning of the position measuring head, the position of the position measuring head in relation to the machine coordinate system of the machine tool, and further determines from the determined positions in the machine coordinate system the position of the workpiece in relation to the machine coordinate system.

According to an advantageous feature of the present invention, the position of the workpiece in relation to the machine coordinate system may not be determined directly from the determined positions of the position measuring head, but rather a measuring probe may be successively moved automatically to positions located in the vicinity of the determined positions of the position measuring head. At each of these positions, the measuring probe may be moved in the direction of the workpiece, wherein the position of the measuring probe may be determined when the measuring probe touches the workpiece. The position of the workpiece in relation to the machine coordinate system may then be determined from the determined positions of the measuring probe. This approach allows a highly precise determination of the position of the workpiece clamped in the workpiece clamping device.

According to yet another advantageous feature of the present invention, the position and orientation of the workpiece in relation to the machine coordinate system may be determined from the determined positions of the measuring probe. The workpiece can be very precisely machined if the orientation of the workpiece, i.e. the orientation of the workpiece relative to the machine coordinate system, is also determined in addition to its position.

According to still another advantageous feature of the present invention, the position of the position measuring head may be determined in relation to a machine coordinate system of the machine tool after each positioning of the position measuring head, wherein the position of the position measuring head may be determined by operating a pushbutton arranged on the position measuring device. This approach enables a particularly user-friendly determination of the position of the workpiece by an operator.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a machine tool according to the present invention;

FIG. 2 shows a schematic block diagram of a detail of the machine tool of FIG. 1; and

FIG. 3 shows a schematic diagram of position measuring device.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

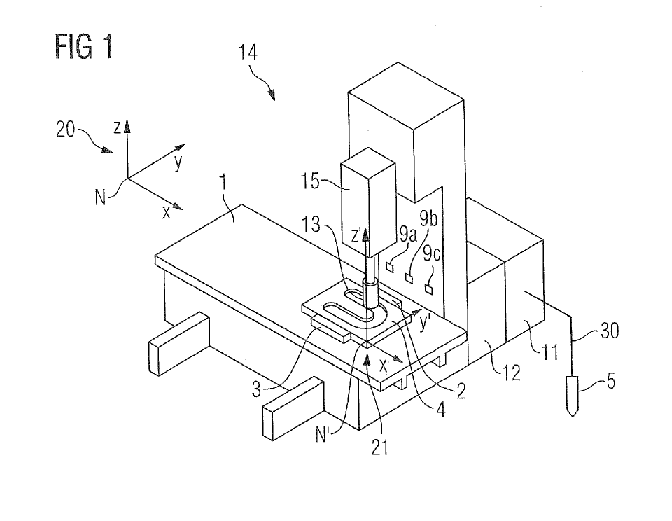

Turning now to the drawing, and in particular to FIG. 1, there is shown a machine tool 14 in a perspective view. The machine tool 14 is used to machine a workpiece 4 which in this exemplary embodiment is clamped in a workpiece clamping device that having two clamping jaws 2 and 3. A motor 15 drives in a rotating fashion a tool 13 which is in the illustrated exemplary embodiment embodied as an end mill. The machine tool 14 has a machine coordinate system 20 with an origin N which is defined, for example, when the machine tool is first started up. The tool 13 in the three-axis machine tool 14 illustrated in the exemplary embodiment can move relative to the workpiece 4 in the X-, Y- and Z-direction. The movement of the tool 13 relative to the workpiece 4 is hereby controlled by a control device 11 which transmits to a drive device 12 desired values for moving the tool 13. The drive device 12 includes the control devices and power converters required to drive the motors of the machine tool.

The movements to be carried out by the tool 13 are prescribed to the control device 11 in the form of a so-called parts program. The parts program includes a plurality of control commands specifying a movement to be carried out by the tool 13 in relation to a workpiece coordinate system 21. The workpiece coordinate system 21 has the origin N′. The workpiece coordinate system 21 is typically selected so as to correspond to the position of the workpiece. The workpiece coordinate system 21 has the directions X′, Y′ and Z′, which correspond to the orientation of the workpiece 4, i.e. its orientation in three-dimensional space.

The parts program generally specifies the movements to be performed by the tool 13 relative to the workpiece coordinate system 21, and thus with reference to the position and orientation of the workpiece 4. The control device 11 then converts the data of the parts program referenced to the workpiece coordinate system 21 into corresponding coordinates in the machine coordinate system 20. Before the workpiece 4 is machined, the position of the workpiece 4 relative to the machine coordinate system and, if necessary, the orientation of the workpiece 4 relative to the machine coordinate system 20 must be determined through measurements. It should be noted that, for example, the X′-axis of the workpiece coordinate system 21 need not necessarily run parallel to the X-axis of the machine coordinate system 20. For example, the clamping jaws 2 and 3 may be slightly rotated in the X-Y-plane so that the X′-axis of the workpiece coordinate system 21 does not run parallel to the X-axis of the machine coordinate system 20.

For the sake of clarity, FIG. 1 does not illustrate the motors of the machine tool 14 which are provided for the translatory movement of the motor 15 and thus of the tool 13 in the X-, Y- and Z-direction.

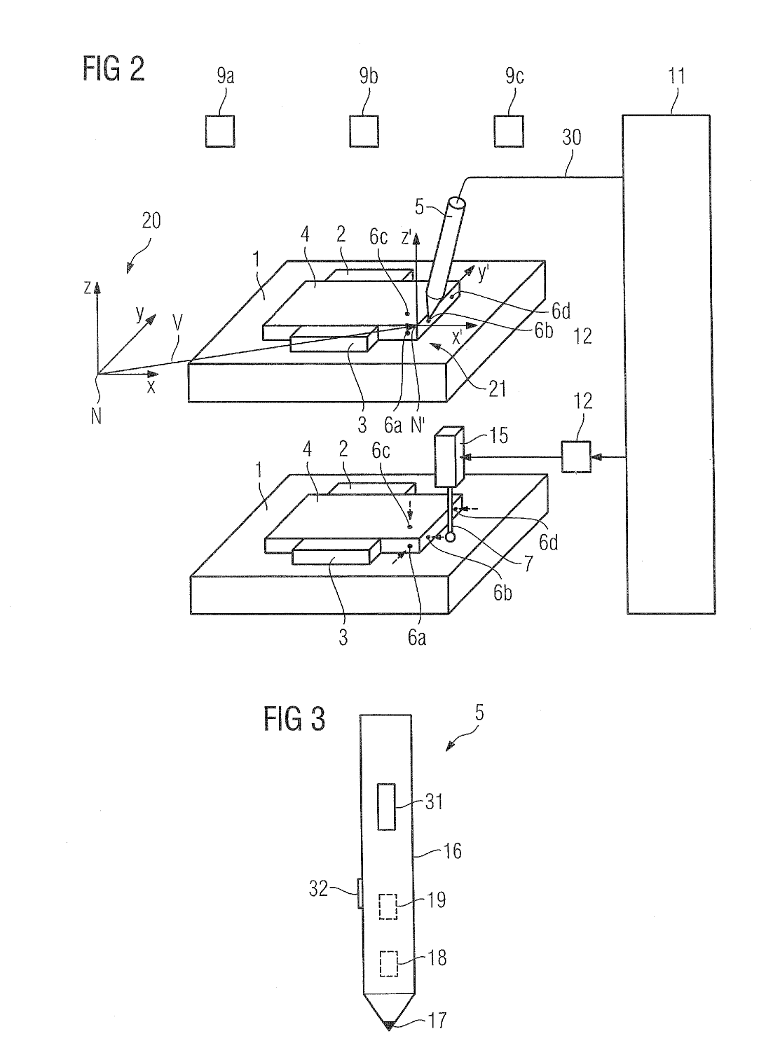

According to the invention, the machine tool 14 has a position measuring device 5 which in the context of the exemplary embodiment is connected to the control device 11 via a wired connection 30. Alternatively, however, the connection 30 can also be implemented as a wireless or radio link. The position measuring device 5 is schematically illustrated in an enlarged scale in FIG. 3. For determining the position, the position measuring device 5 is hereby held in the hand of the operator of the machine tool and moved by hand in three-dimensional space. In the exemplary embodiment, the position measuring device 5 has an elongated holding element 16 which enables the operator to hold it comfortably in his hand. A position measuring head 17 is arranged at one end of the position measuring device 5, i.e. in the exemplary embodiment at the end of the holding element 16. In the exemplary embodiment, the position measuring head 17 is shaped as a tip, but may also have a spherical or some other shape. In the exemplary embodiment, an antenna (not illustrated in FIG. 3) is arranged inside the position measuring head 17. The antenna receives the signals from three transmitters 9a, 9b and 9c arranged at different positions on the machine tool 14 (see FIGS. 1 and 2), and transmits the received signals to an evaluation unit 31 arranged inside the holding element 16. The evaluation unit 31 determines the position of the position measuring head 17 in three-dimensional space (“Micro-GPS”) from differences in the propagation times of the high-frequency electromagnetic waves emitted by the transmitters 9a, 9b and 9c. The evaluation unit 31 transmits the measured position of the position measuring head 17 via the connection 30 to the control device 11. It should be noted here that the evaluation unit 31 can alternatively also be a component of the control device 11, in which case the antenna is connected to the control device 11 directly via the (in this case wired) connection 30, with the position of the position measuring head 17 being determined in the control device 11.

Alternatively, as illustrated in FIG. 3 by dashed lines, the antenna can, however, also be present as an antenna 18 arranged outside the position measuring head 17. In this alternative embodiment of the evaluation unit 31, the position of the position measuring head 17 is determined the known distance between the antenna 18 and the position measuring head 17 and the orientation of the position measuring device 5 in three-dimensional space determined by an orientation unit 19 and transmitted to the control device 11 via the connection 30. It should be noted that in this embodiment of the position measuring device 5, the evaluation unit 31 can be a component of the control device 11, wherein the antenna is directly connected to the control device 11 via the—in this embodiment—wired connection 30 and the position of the position measuring head 17 is determined in the control device 11.

In the exemplary embodiment, the position measuring device 5 has a pushbutton 32. The position of the position measuring head 17 is determined when the user presses the pushbutton 32. The position of the position measuring head 17 can here be determined, for example, by continuously determining the position of the position measuring head 17 with the evaluation unit 31 and considering the just determined position as the actual position of the position measuring head 17 when the pushbutton 32 is actuated.

Alternatively, however, the position of the position measuring head 17 can, for example, also be determined by determining the position of the position measuring head 17 with the evaluation unit 31 not continuously, but only when the pushbutton 32 is actuated.

FIG. 2 shows in the form of a schematic block diagram in an enlarged scale the elements of the machine tool 14 which are important to an understanding of the invention. A workpiece 4 to be machined is clamped on the machine table 1 in a workpiece clamping device which in the context of the exemplary embodiment consists of the two clamping jaws 2 and 3. The machine tool 14 has a machine coordinate system 20, wherein the position of the origin N of the machine coordinate system 20 is defined, for example, when the machine tool 14 is first started up. The machine coordinate system 20 has an X-, a Y- and a Z-direction.

Before machining of the workpiece 4 can begin, the position of the workpiece 4 in relation to the machine coordinate system 20 must be determined. According to the invention, this is performed by the position measuring device 5. To determine the position of the workpiece 4, the operator holds the position measuring device 5 in his hand and, in the present exemplary embodiment, guides the position measuring head 17 of the position measuring device 5 successively by hand to different measuring positions 6a, 6b, 6c and 6d located on the surface of the workpiece 4. After each positioning of the position measuring head 17 at the different positions 6a to 6d, the position of the position measuring head 17 is determined in relation to the machine coordinate system 20 of the machine tool 14. To determine the position 6a, the operator positions the position measuring head 17 at the position 6a, i.e. aims at the position 6a by a hand movement, so that the position measuring head 17 of the position measuring device 5 touches the workpiece 4 at the position 6a. Subsequently, the position of the position measuring head 17 is determined in relation to the machine coordinate system 20 of the machine tool 14 by actuating the pushbutton 32 of the position measuring device 5. This operation is repeated until all the positions 6a to 6d have been determined. To determine the position N′ of the workpiece 4 in three-dimensional space, only the positions 6a, 6b and 6c need to be determined with the position measuring device 5. The position N′ of the workpiece 4 in relation to the machine coordinate system 20 is determined from the positions 6a, 6b and 6c determined with the position measuring head 17. The coordinate of the position N′ in X-direction corresponds in this case to the coordinate of the position 6b in X-direction. The coordinate of the position N′ in Y-direction corresponds to the coordinate of the position 6a in Y-direction. The coordinate of the position N′ in Z-direction corresponds to the coordinate of the position 6c in Z-direction.

The position N′ of the workpiece 4 forms the origin of the workpiece coordinate system 21. It should be noted here that if, unlike in the exemplary embodiment where the position of the workpiece 4 in three-dimensional space is determined, only the position of the workpiece 4 in the X- and the Y-directions needs to be determined, then only the positions 6a and 6b are determined with the position measuring device 5.

The so-called origin displacement vector V represents the difference between the position of the origin N′ of the workpiece coordinate system 21 and the position of the origin N of the machine coordinate system 20.

FIG. 2 illustrates the workpiece coordinate system 21 with the coordinate axes X′, Y′ and Z′. Occasionally, the workpiece may not be aligned parallel to the X-direction since, for example, the two clamping jaws 2 and 3 do not run exactly parallel to the X-direction, but are slightly rotated about the Z-axis, causing the direction X′ of the workpiece coordinate system 21 not to run parallel to the direction X of the machine coordinate system 20. It is therefore generally reasonable to determine the orientation of a workpiece in addition to its position N′, i.e., its orientation in three-dimensional space in relation to the machine coordinate system 20. To this end, an additional position 6d on the surface of the workpiece may then be determined with the position measuring device 5, with the control device 11 determining from the positions 6b and 6d the orientation of the workpiece and hence the orientation of the direction X′ of the workpiece coordinate system 21 in relation to the direction X of the machine coordinate system 20. When the tool 13 is later moved, the control device 11 can then compensate for the orientation of the workpiece 4 that does not run parallel to the X-direction of the machine coordinate system 20.

When it becomes necessary to very precisely determine the position and, if suitable, the orientation of the workpiece, an additional method step may be appended in the above method. In this case, unlike in the aforedescribed embodiments, the position and, if suitable, the orientation of the workpiece 4 in relation to the machine coordinate system 20 are not directly determined from the determined positions of the position measuring head 17, but rather a measuring probe 7 (see FIG. 2, lower part of the drawing) is automatically moved by the drive system 12 of the machine tool 14 under control of a measurement subprogram executed in the control device 11 successively to positions located in the vicinity and, advantageously, in the direct vicinity of the determined positions 6a, 6b, 6c and, optionally, 6d of the position measuring head 17.

The measuring probe 7 is a commercially available measuring probe which in the context of the exemplary embodiment is clamped in the tool clamping device of the motor 15 rather than that of the tool 13. In each of the positions to which the measuring probe 7 moves, the measuring probe 7 is moved automatically by the control device 11 toward the workpiece, as illustrated at the bottom in FIG. 2 by arrows shown with dashed lines. The position of the measuring probe 7 is automatically determined by the control device when the measuring probe 7 touches the workpiece 4. Thereafter, the position N′ of the workpiece 4 in relation to the machine coordinate system 20 is determined from the positions of the measuring probe 7 determined in this way. This allows a very precise determination of the position N′ of the workpiece 4 and its orientation in three-dimensional space in relation to the machine coordinate system 20.

With the invention, currently used measuring methods with a measuring probe can be significantly simplified. If the measuring accuracy of the position measuring system consisting of the position measuring device and the transmitters is sufficiently precise, the otherwise required determination with a measuring probe is entirely eliminated. If the measuring precision of the position measuring system is insufficient, the measuring operation with a measuring probe can be simplified by eliminating the currently still required manual pre-positioning of the measurement probe with a tapping operation or a hand wheel operation.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method for determining a position of a workpiece clamped in a workpiece clamping device in a machine tool, comprising the steps of:
successively positioning a position measuring head of a position measuring device held in the hand of an operator at different positions on a surface of the workpiece,
determining, after each positioning of the position measuring head, a position of the position measuring head in relation to a machine coordinate system of the machine tool, and
determining from the determined positions in the machine coordinate system the position of the workpiece in relation to the machine coordinate system.

2. A method for determining a position of a workpiece clamped in a workpiece clamping device in a machine tool, comprising the steps of:
successively positioning a position measuring head of a position measuring device automatically at different positions located near a surface of the workpiece,
moving a measuring probe from the positions located near the positions determined with the position measuring head toward the workpiece,
determining, after each move of the position measuring probe, a position of the position measuring probe in relation to a machine coordinate system of the machine tool when the measuring probe touches the workpiece, and
determining from the determined positions of the measuring probe the position of the workpiece in relation to the machine coordinate system.

3. The method of claim 1, wherein the position and an orientation of the workpiece in relation to the machine coordinate system are determined from the determined positions of the position measuring head.

4. The method of claim 2, wherein the position and an orientation of the workpiece in relation to the machine coordinate system are determined from the determined positions of the measuring probe.

5. The method of claim 1, wherein after each successive positioning of the position measuring head, the position of the position measuring head is determined in relation to the machine coordinate system by actuating a pushbutton arranged on the position measuring device.

6. The method of claim 2, wherein after each successive positioning of the position measuring head, the position of the position measuring head near the surface in relation to the machine coordinate system is determined by actuating a pushbutton arranged on the position measuring device when the measuring probe touches the workpiece.

7. A machine tool comprising:
a plurality of transmitters arranged on the machine tool;
a workpiece clamping device for clamping a workpiece;
a position measuring device comprising a position measuring head with a receiver, said position measuring device constructed to be held in the hand of an operator;
an evaluation device determining from signals transmitted by the transmitters arranged on the machine tool a position of the position measuring head in three-dimensional space;
a control device operatively connected to the position measuring device, said control device converting instructions of a parts program to coordinates in a machine coordinate system; and
a drive device moving a tool based on the converted instructions in the machine coordinate system, wherein
the operator successively positions the position measuring head at different positions on the surface of the workpiece, the evaluation device determines, after each positioning of the position measuring head, the position of the position measuring head in relation to the machine coordinate system of the machine tool, and the evaluation device further determines from the determined positions in the machine coordinate system the position of the workpiece in relation to the machine coordinate system.
